(19) United States
(12) Patent Application Publication
(10) Pub. No.: US 2003/0021866 A1
(43) Pub. Date: Jan. 30, 2003

(54) Method for making wine

(75) Inventor: Richard L. Antrim, Solon, IA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Grain Processing Corporation, Muscatine, IA

(21) Appl. No.: 10/202,123

(22) Filed: Jul. 24, 2002

Related U.S. Application Data
(60) Provisional application No. 60/307,463, filed on Jul. 24, 2001.

(51) Int. Cl. C12C 11/00

(52) U.S. Cl. 426/11

(57) ABSTRACT

Disclosed are methods for preparing wine. In accordance with one disclosed method, a high-purity maltose product is added to the must prior to or contemporaneously with fermentation in order to increase the level of fermentable sugar. In accordance with the second embodiment, a high-purity maltose product is added to a fermented wine in order to sweeten the wine.

### RELATED APPLICATION

This application claims priority to prior U.S. provisional application Serial No. 60/307,463, filed Jul. 24, 2001, the contents of which are incorporated by reference.

### TECHNICAL FIELD OF THE INVENTION

The invention is in the field of oenology.

### BACKGROUND

Sugar plays an important role in wine making. Many wines are made by adding sugar to the grape must prior to or contemporaneously with fermentation, in particular wines made in the eastern United States. Sugar is added prior to fermentation to provide sufficient fermentable material in the must to result in adequate alcohol content in the final wine product. In addition, many wines are sweetened after fermentation by adding sugar and/or other ingredients to provide a sweet taste in the wine. A famous example of the latter is Champagne, in which a sparkling wine is dosed with a solution of sugar and brandy after fermentation has progressed to completion.

The sugar typically used in such applications is sucrose, dextrose or glucose (“grape sugar”), or fructose. It is believed that the use of these sugars, in particular dextrose, can lead to off-flavors in the wine when added to the must. It is a general object of the invention to overcome this drawback.

### THE INVENTION

The invention provides a method for making wine and a wine prepared thereby. Two non-exclusive embodiments are contemplated. In accordance with the first embodiment of the invention, wine is prepared by providing a fermentable material, which is almost always grape must, and ameliorating the wine by adding a high-purity maltose product to the fermentable material prior to or contemporaneously with fermenting the fermentable material. In accordance with a second embodiment of the invention, a high-purity maltose product is added after the fermentation of the must or other fermentable material has been completed or substantially completed. The high-purity maltose product most preferably is that disclosed in pending U.S. patent application Ser. No. 09/786,027, which is hereby incorporated by reference in its entirety. The invention contemplates embodiments wherein other sugars, even dextrose, are added along with maltose. In preferred embodiments of the invention, however, such other sugars are not added.

### DETAILED DESCRIPTION OF THE PREFERRED EMBODIMENTS

Wine may be defined as a fermented product resulting from the fermentation of the must of a fruit. While other wines are known, most wines are made from grapes, often the grapes of various cultures of Vitis vinifera, but also, particularly in the eastern United States, Vitis labrusca and Vitis rotundifolia. Wine may be made with a hybrid of any one or more of the foregoing grapes. The grapes used to make the wine may be partially desiccated, for example, by drying or use of the mold Botrytis cenera (“noble rot”).

Wine may be made in accordance with any method for making wine known or otherwise found to be suitable. The invention is contemplated to be applicable to any variety of wine, including all reds, whites, and rose-wines, and including fortified wines, sparkling wines, table wines, light (low-alcohol) wines, and so forth.

Innumerable methods for preparing wine are known. Generally, grape must is provided. Typically, the grapes are crushed to provide the must, either mechanically or via other means, such as via carbonic maceration. The must may be treated in various steps prior to fermentation, such as by clarification, filtration, centrification, or heat treatment. Sulfur dioxide (SO₂) often is added prior to fermentation to inhibit the activity of undesired bacteria or yeasts that may be present in the must.

In any event, the must is fermented, by which is contemplated the action of yeast to convert the sugar present in the must to alcohol, carbon dioxide, and other products. Generally, one or more variants of the yeast Saccharomyces cervisiae is used. In many regions of the world, the grapes in long-established wine growing areas are covered with Saccharomyces cells on the vine, and it is not necessary to add yeast. Other yeasts as may naturally be present or as may be added may be used in connection with the fermentation step. Among such yeasts are the Brettonomycos yeasts. An ideal yeast concentration is about 1,000,000 cells/ml must.

A wide range of fermentation temperatures and times may be employed; for instance, the fermentation may take place for only a few days, or may continue for several weeks. Depending on the intended type of wine, the skins of the grape may be removed or may be allowed to remain in contact with the grape juice during at least a portion of the fermentation. Where seeds and skins remain in the must during fermentation, these often float to the surface, leaving a “cap.” The cap must be pushed back into the must periodically to avoid growth of undesired bacteria; in large-scale operations, liquid in the must is recirculated over the cap. In any case, the pomace generally is removed prior to termination of the fermentation.

The fermentation is then substantially or completely terminated. The fermentation may terminate naturally or may be terminated by any means known or otherwise found to be suitable. Fermentation will terminate if the sugar content in the must becomes too low, thereby “starving” the yeast. Moreover, if the alcohol content rises to a sufficient level, the yeast will be deactivated. Fermentation also may terminate prematurely if the temperature is too low or high, or if the fermentation is conducted under pressure. Temperature and pressure may be altered during fermentation to cause the fermentation to cease. Those skilled in the art will appreciate that many variance in the fermentation conditions may be employed to achieve various desired alcohol and sweetness levels in the wine.

In many cases, particularly for white wine and sparkling wines, a second fermentation, known as maltolactic fermentation, is performed. In this step, malic acid is converted to lactic acid and carbon dioxide. In many instances, lactic acid bacteria is added to accomplish the second fermentation.

After fermentation has been terminated, the wine is racked, by which is contemplated separation of the fermented liquid from the lees. Typically, the wine is stabilized or filtered, bottled, and cellared. The alcohol content of the wine may be lowered, such as by vacuum distillation or reverse osmosis. Some wines are pasteurized or otherwise treated to deactivate bacteria or yeasts that may be present.

In accordance with the first embodiment of the invention, a high-purity maltose product is added to be must or to the partially fermented must prior to or during fermentation. As disclosed in co-pending application Ser. No. 09/796,027, a high-purity maltose product may be prepared by treating starch with a betaamylase enzyme in order to yield a high-purity maltose product. The product may have upwards of 70% maltose based on the total content of saccharide. In preferred embodiments, the maltose content is about 85% or greater, and in some embodiments, greater than about 90%, and in even more preferred embodiments, greater than about 95%. In these embodiments, the contents of saccharides having a degree of polymerization (“DP”) of 1 and of saccharides in the DP 3 to 10 range is kept to a low level, in some embodiments, less than about 10%, and in preferred embodiments, less than about 5%. As further disclosed in co-pending application Ser. No. 09/796,027, the dextrose content often is zero or very close to zero.

The grape must may be ameliorated with the maltose product or an aqueous solution of the maltose product. The amelioration may be in any amount deemed suitable by the winemaker. Generally, up to about 35% by volume of a solution of the high-maltose product may be added. Ideally, the pH of the ameliorated must should be in the range of about 3.0 to 3.5, and the fermentable sugar content should be in the range of about 21 to 25%, inclusive of the grape brix.

In accordance with the second non-exclusive embodiment of the invention, the high-purity maltose product is added to a fermented wine after fermentation has been terminated or substantially terminated. Generally, if the alcohol content of the wine is sufficiently high, or if no yeast is present, little or no fermentation of the added sugar will occur. For example, in the preparation of a sparkling wine, the wine may be dosed with a solution of the high-purity maltose product in brandy. It is contemplated that via such addition sparkling wines may be brought to any desired sugar level such as brut, sec, extra-sec, demi-doux, or doux.

It is contemplated that both embodiments of the invention may be employed in the preparation of a single wine. That is, the high-purity maltose product may be added both prior to or contemporaneously with the fermentation step and after the fermentation has been largely completed, albeit for different purposes.

While particular embodiments of the invention have been shown, it will be understood that the invention is not limited thereto since modifications may be made by those skilled in the art, particularly in light of the foregoing teachings. For instance, there are many varieties in methods for producing wine. Not all of the winemaking steps described hereinabove may be employed, and in some cases additional steps and ingredients may be employed. It is, therefore, contemplated by the appended claims to cover any such modifications as incorporate those features which constitute the essential features of these improvements within the true spirit and scope of the invention.

What is claimed is:

1. A method for preparing wine, comprising:
providing a must;
adding to said must a maltose product having maltose content of at least about 70% based on dry saccharide weight;
fermenting said must; and
at least substantially terminating said fermentation to provide a wine.

2. A method according to claim 1, further comprising adding a maltose product having a maltose content of at least 70% by dry saccharide weight after said at least substantial termination of said fermentation.

3. A method for preparing a wine comprising:
providing a must;
fermenting said must;
at least substantially terminating said fermentation to provide a wine; and
adding a maltose product after said fermentation has been terminated, said maltose product including maltose in an amount of at least 70% by dry saccharide weight.

4. A method for preparing wine, comprising:
providing a fermentable material;
adding to said must a maltose product having maltose content of at least about 70% based on dry saccharide weight;
fermenting said fermentable material; and
at least substantially terminating said fermentation to provide a wine.

5. A wine prepared in accordance with the method of claim 1.

6. A wine prepared in accordance with the method of claim 2.

7. A wine prepared in accordance with the method of claim 3.

8. A wine prepared in accordance with the method of claim 4.
